(19) United States
(12) Patent Application Publication
(10) Pub. No.: US 2010/0013116 A1
(43) Pub. Date: Jan. 21, 2010

(54) Method and System for Removing Polychlorinated Biphenyls from Plastics

(76) Inventors: Peter C. Blyth, Valrico, FL (US); David L. Bangs, Alpharetta, GA (US)

Correspondence Address: KING & SPALDING, 1180 PEACHTREE STREET , NE, ATLANTA, GA, 30309-3521, US

(21) Appl. No.: 12/506,907

(22) Filed: Jul. 21, 2009

Related U.S. Application Data
(60) Provisional application No. 61/135,508, filed on Jul. 21, 2008.

(51) Int. Cl. C08J 11/08; B29B 9/02

(52) U.S. Cl. 264/141; 521/40

(57) ABSTRACT

Removing PCBs from recycled plastic materials. A reactor can volatilize the PCBs from interior portions of the plastic materials under pressure conditions below atmospheric pressure and temperatures sufficient to melt the plastic material. The reactor typically includes agitation that exposes the plastic material to the atmosphere within the reactor to promote the volatilization of the PCBs.

### STATEMENT OF RELATED PATENT APPLICATIONS

This non-provisional patent application claims priority under 35 U.S.C. § 119 to U.S. Provisional Patent Application No. 61/135,508, titled Method and System for Removing Polychlorinated Biphenyls from Plastics, filed Jul. 21, 2008. This provisional application is hereby fully incorporated herein by reference.

### FIELD OF THE INVENTION

This invention relates to removing polychlorinated biphenyls (PCBs) from plastic material and specifically using vacuum extraction to remove PCBs from molten plastics recovered from waste products.

### BACKGROUND OF THE INVENTION

Recycling of waste materials is highly desirable from many viewpoints, not the least of which are financial and ecological. Properly sorted recyclable materials can often be sold for significant revenue. Many of the more valuable recyclable materials do not biodegrade within a short period, and so their recycling significantly reduces the strain on local landfills and ultimately the environment.

Typically, waste streams are composed of a variety of types of waste materials. One such waste stream is generated from the recovery and recycling of automobiles or other large machinery and appliances. For examples, at the end of its useful life, an automobile is shredded. This shredded material is processed to recover ferrous and non-ferrous metals. The remaining materials, referred to as automobile shredder residue (ASR), which may still include ferrous and non-ferrous metals, including copper wire and other recyclable materials, is typically disposed of in a landfill. Recently, efforts have been made to further recover materials, such as non-ferrous metals including copper from copper wiring and plastics. Similar efforts have been made to recover materials from white good shredder residue (WSR), which are the waste materials left over after recovering ferrous metals from shredded machinery or large appliances. Other waste streams that have recoverable materials may include electronic components, building components, retrieved landfill material, or other industrial waste streams. These recoverable materials are generally of value only when they have been separated into like-type materials. For example, plastics from these waste streams are separated and further processed into a form suitable for resale. A variety of plastics may be contained within a waste stream. Some such plastics include polypropylene (PP); polyethylene (PE); acrylonitrile butadiene styrene (ABS); polystyrene (PS), including high impact polystyrene (HIPS), and polyvinyl chloride (PVC). These materials are more valuable if separated, at least into “light” plastics (PP and PE) and “heavy” plastics (ABS and PS).

However, some plastic materials are contaminated by chemicals that prevent the resale of those plastics. For example, during the process of shredding automobiles, the plastic materials can be contaminated with PCBs. Due to the similarity in physical nature between the PCB molecules and the plastic, the PCBs are attracted to and absorbed by the plastic. Most of the contamination is on the surface of the plastic. However, the PCBs can be absorbed into the plastic materials. In order to resell any recycled plastic materials, the PCBs must be removed from the plastic without compromising the plastic itself.

In view of the foregoing, a need exists for methods and systems for removing PCBs from recycled plastic materials.

### SUMMARY OF THE INVENTION

The present invention provides methods and systems for removing PCBs from recycled plastic materials. In one aspect of the present invention, a method for removing polychlorinated biphenyls (PCBs) from plastic material is provided. The method includes the steps of: (1) receiving a waste stream comprising plastic material contaminated with PCBs; (2) adding the waste stream to a reactor, where the pressure within the reactor is typically maintained below 100 millibars; (3) establishing a temperature of the reactor above the melting point of the plastic material to create a molten plastic material; (4) agitating the waste material; and (5) extruding the molten plastic material following volatilization of at least a fraction of the PCBs from the plastic material.

In another aspect of the invention, a method for removing polychlorinated biphenyls from plastic material is provided. The method includes the steps of: (1) receiving a waste stream comprising plastic material contaminated with PCBs; (2) washing the waste stream; (3) adding the waste stream to the kneader reactor, wherein the pressure within the kneader reactor is typically maintained at or below 10 millibars; (4) establishing a temperature of the kneader reactor above the melting point of the plastic material to form a molten plastic material; (5) agitating the waste material; and (6) extruding the molten plastic material following volatilization of at least a fraction of the PCBs from the plastic material.

### BRIEF DESCRIPTION OF THE DRAWINGS

FIG. 1 depicts an overall process flow diagram for removing polychlorinated biphenyls from recycled waste material in accordance with an exemplary embodiment of the present invention.

FIG. 2 depicts a system diagram for a system capable of removing polychlorinated biphenyls from recycled waste material in accordance with an exemplary embodiment of the present invention.

### DETAILED DESCRIPTION OF THE EXEMPLARY EMBODIMENTS

Exemplary embodiments of the present invention provide systems and methods for removing polychlorinated biphenyls (PCBs) from plastics recovered in recycled waste streams. Aspects of the invention employ vacuum extraction to volatilize the PCBs from molten plastic without destroying the utility of the plastic.

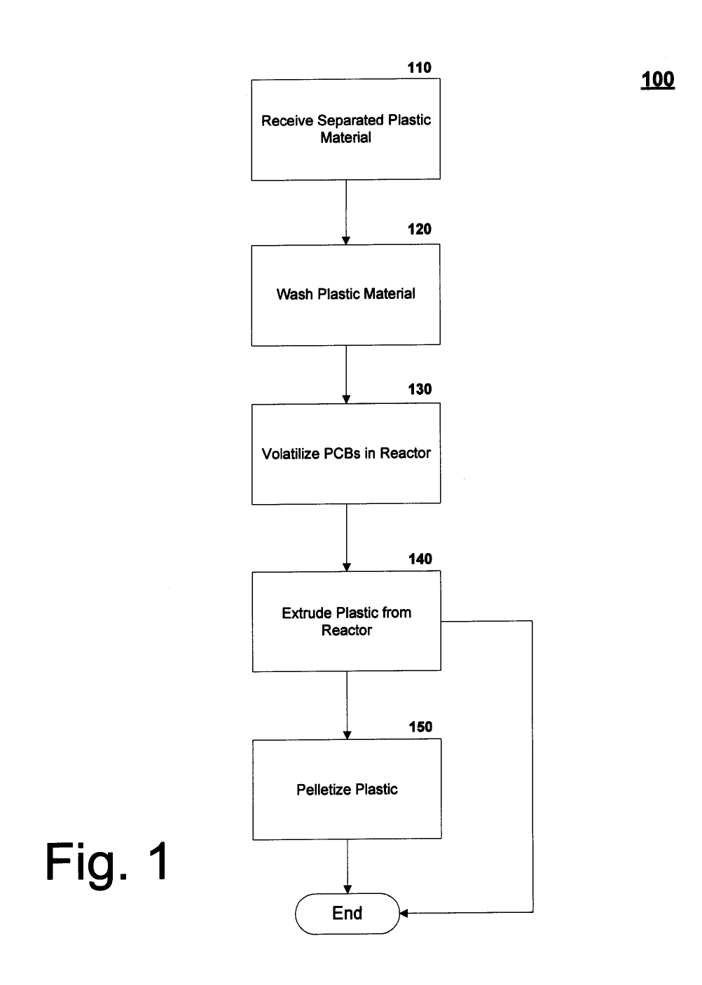

FIG. 1 depicts an overall process flow diagram for removing polychlorinated biphenyls from recycled waste material in accordance with an exemplary embodiment of the present invention. Referring to FIG. 1, the process 100 begins at step 110 by receiving separated plastic material that is potentially contaminated with PCBs. Although this exemplary embodiment describes processing recycled materials and specifically recycled ASR materials, the process 100 would work for other sources of plastic contaminated with PCBs.

Processes for separating plastic materials in a waste stream are known. One such process employs density separation to separate plastics from other, more dense materials, such as metals. Typically, the waste material, including the plastics, are sized to 1-2 inches, on average, but the size can vary up to 5-6 inches. The sized material is then added to one or more sink/float tanks. Each tank includes a separation medium. This medium can be water, with a density of 1.0 g/cc. Chemicals, such as salt, magnesium sulphite, calcium nitrate, and calcium chloride, may be added to the water to increase the medium's density, such as between 1.0 g/cc and 1.4 g/cc or higher. Another possible medium is sand. Some light plastics, such as PP and PE, float in a tank with a density of 1.0 g/cc. ABS and HIPS typically have densities of approximately 1.05 g/cc, such that they would sink in a tank with a density of 1.0 g/cc. Some of these materials may have densities in the 1.1 to 1.2 g/cc range. In that case, a second tank with a density of 1.2 grams/cc may be used to “float” the ABS and HIPS, separating this material from the other, more dense, waste material. Of course, other separation techniques can be employed. The invention described here is independent of the process used to separate the plastics from other waste materials.

The separated plastics may undergo further processing to remove other undesirable material that remains in the plastic streams. For example, a rollback conveyor, which includes an upwardly-inclined conveyor, may be used to remove rounded material, such as foam, from the plastic stream. As the material move on the conveyor, the round foam and similar material rolls back down the conveyor, as it does not create enough friction to remain on the conveyor as it travels. The material that is removed with this process is typically waste.

Similarly, the plastic material may be transferred to a magnetic belt. Here, any ferrous debris is removed. For example, carpet “fluff,” which is carpet fragments from an automobile that has ferrous metal threads, would be removed at this point. This ferrous debris would typically be waste. Other processes may be employed to remove undesirable plastics, such as talc-filled PP, glass filled, and PVC. These processes may be skipped or additional steps added to arrive at a concentrated plastic stream that can be processed to remove PCBs. The plastic may be further reduced in size as necessary. Alternatively, these pre-processing activities could be done prior to concentrating the plastic materials in a sink/float tank.

Also, preprocessing steps may be taken to remove polyurethane, wood, rubber, and other preferential PCB absorbers. Porous materials such as wood and rubber, or materials chemically similar to PCBs such as polyurethanes preferentially absorb PCBs such that the PCB concentrations in these materials may be a factor of ten higher than other materials in the waste stream.

At step 120, the plastic material, either the light plastic (PP and PE) or heavy plastic (ABS and HIPS), is added to a wash tank or other cleaning apparatus. The wash tank includes water and a detergent. The plastic, water, and detergent are agitated. Many ways to agitate a tank are known. In one embodiment, an in-tank agitator could be used, such as a propeller.

In another embodiment, the plastic material may be processed through one or more hydrocyclones. The water processed through the hydrocyclones may include detergent. The processing in the hydrocyclone can cause sufficient agitation to clean the plastic. The hydrocyclones can also be used to further separate the plastic materials from other undesirable material, such as wood.

In yet another exemplary embodiment, the plastic is agitated by pumping the wash tank contents through a static mix pipe and recirculating the material to the tank. The static mix pipe is a pipe that includes fixed baffles or other protrusions that force plastic/water/detergent mixture to take a tortuous path through the pipe. This movement causes the agitation that allows the plastic to be cleaned. In another alternative embodiment, both a propeller or static mixer could be used or another type of agitation could be employed. Each of these configurations may also include a rinse tank to rinse the detergent from the plastic. Of course, other techniques for cleaning the outside surface of the plastic can be used.

This washing step removes PCBs that contaminate the surface of the plastic, such as PCB-bearing oils. However, PCBs may still have been absorbed by the plastic. Also, the washing step may not completely remove all PCBs on the surface of the materials. At step 130, the plastic material is added to a reactor, such as a kneader reactor. The kneader reactor can heat the plastic material to a molten state while the kneaders are under a vacuum. One such kneader reactor can be obtained from List USA, Inc., although other kneader reactors or other types of reactors could be used. The kneader reactor can include single, twin, or multi-shaft configurations and may be continuous or batch feed reactors.

PCBs are not a single chemical compound. Instead, 209 possible PCBs exist, although only about 130 have been used commercially. At atmospheric pressure (1013 millibars), the boiling points of these PCBs range from 310 degrees Celsius to 450 degrees Celsius. In comparison, the melting point for PP and PE range from 190 degrees Celsius to 275 degrees Celsius. However, at reduced pressures, the boiling points of the PCBs are reduced. For example, at 100 millibars pressure, the boiling points range from 210 degrees Celsius to 330 degrees Celsius. At 20 millibars pressure, the boiling points range from 160 degrees Celsius to 270 degrees Celsius. At 10 millibars pressure, the boiling points range from 135 degrees Celsius to 240 degrees Celsius.

PCBs form distillable water azeotropes that separate upon cooling so the PCBs can be readily separated from the water for disposal and the water reused. As such the plastics melt at or above the reduced pressure distillation temperatures of the PCB azeotropes or pure oils. The plastics will be fluid at the temperatures needed to volatilize the PCBs but not at so high a temperature as to harm the plastics such that they would not have recycle value.

At step 130, the plastic material is added to one end of the kneader reactor. The temperature is raised above the melting point of the plastic, while the pressure is maintained below 100 millibars and preferably less than 10 millibars and even more preferably approximately 1 millibar. The kneader reactor kneads the molten plastic material as it moves down the reactor. The shafts of the reactor maintain the temperature necessary for the plastic to be maintained in a molten state. This kneading process exposes the volume of plastic to the atmosphere in the reactor by forming thin segments of the plastic material. In other words, the plastic material that made up the interior of the plastic piece (and that contains the absorbed PCBs) is moved to an exterior surface of the molten material as part of one of these thin segments and exposed to the atmosphere of the reactor as the material is kneaded. At these temperatures and pressures, the PCBs absorbed onto the plastic volatilize out of the plastic. This process is repeated as the material moves down the reactor. The speed of the material as it moves down the reactor can be adjusted to get sufficient exposure of the material to the reactor atmosphere to ensure adequate volatilization of the PCBs. The PCBs are captured in an off gas system and properly disposed of by a licensed facility that destroys the PCBs.

In an alternative embodiment, the reactor is capable of having either water, steam or water vapor, or other solvents introduced during the vacuum devolatilization of the plastics to allow for steam or solvent distillation of the PCBs from the molten plastic matrix. Steam is necessary for the creation of azeotropes. Typical solvents may include 50/50 acetone/hexane or methylene chloride.

Of course, another type of reactor could be used. The reactor needs to provide the reduced pressures, as low as less than 10 millibars; increased temperatures sufficient to melt and maintain in a molten state the plastic material; and agitation for the molten material sufficiently to form thin segments of the plastic to expose the plastic containing the absorbed PCBs to the atmosphere of the reactor to allow the PCBs to volatilize from the plastic.

At step 140, the molten plastic is extruded from the kneader reactor. A variety of molds can be used to control the shape of the extruded plastic and form the plastic material into a finished product. Screens can be added to screen out any undesirable material that remained in the plastic stream as it is extruded. Optionally, at step 150, the extruded material can be converted into pellets with a pelletizer.

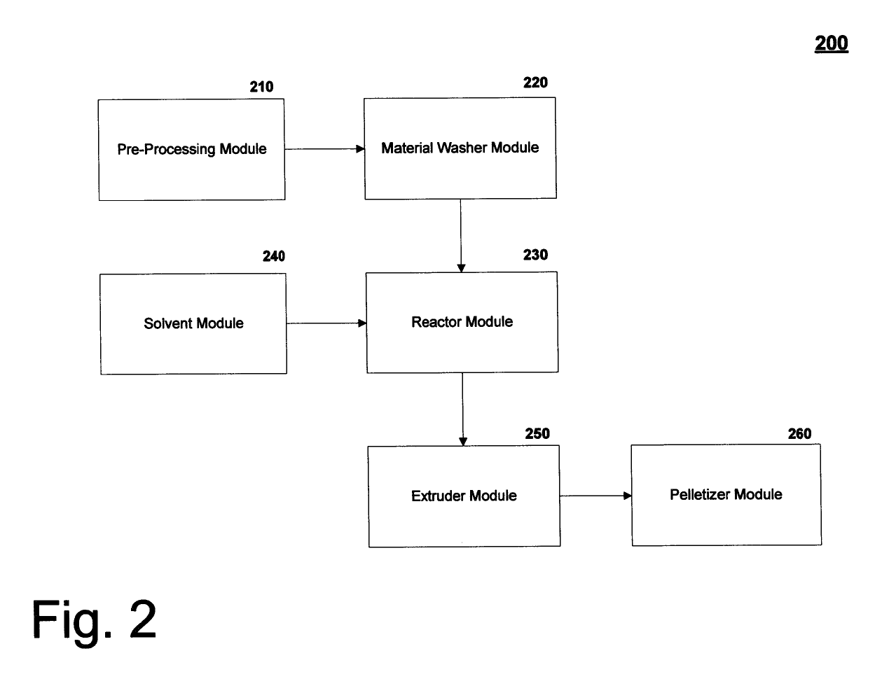

FIG. 2 depicts a system diagram for a system 200 capable of removing polychlorinated biphenyls from recycled waste material in accordance with an exemplary embodiment of the present invention. Referring to FIG. 2, waste material may be processed in a pre-processing module 210. As described above, in connection with FIG. 1, step 110, this module may include a density separator, such as in one or more sink/float tanks; a rollback conveyor; and a magnetic separator. This module may also include size reducers, air separators, color separators, or other processors that concentrate one or more types of plastic in the waste material to be processed to remove PCBs. Any combination of these components may form the pre-processing module 210.

The waste material may be washed in a material washer module 220. As described above, in connection with FIG. 1, step 120, the material washer module 220 can be a variety of forms, such as wash tank, hydrocyclone, static mixing pipe, or other known washing device capable of removing PCB-bearing oils from the outside surface of the waste material.

The waste material is processed in a reactor 230. The reactor 230, such as a kneader reactor, is capable of agitating molten plastic within the waste material such that plastic material that was originally below the surface of the plastic is exposed to the atmosphere of the reactor. The reactor is also capable of maintaining pressure below atmospheric pressure and temperatures sufficient to melt the plastic within the waste material and volatilize PCB contaminants in the plastic. This invention is not limited to a kneader reactor and other reactors capable of maintaining pressure below atmospheric pressure and temperatures sufficient to melt the plastic within the waste material and volatilize PCB contaminants in the plastic while agitating the plastic may be used.

A solvent module 240 may be added to the system 200. The solvent module 240 introduces water/steam or other solvents into the reactor 230 during the vacuum devolatilization of the plastics to allow for steam or solvent distillation of the PCBs from the molten plastic matrix.

The molten plastic is extruded from the reactor 230 through an extruder module 250. A variety of molds can be used to control the shape of the extruded plastic. Screens can be added to the extruder module 250 to screen out any undesirable material that remained in the plastic stream as it is extruded. The extruder module 250 may be integral with the reactor 230.

A pelletizer module 260 may be included in the system 200. The pelletizer module 260 forms the plastic into pellets. Pellets are a favored form for buyers of this recycled material. The pelletizer module 260 may be integral with the extruder module 250.

One of ordinary skill in the art would appreciate that the present invention provides methods and systems for removing PCBs from recycled plastic materials. These methods and systems employ a reactor that volatilizes the PCBs from interior portions of the plastic materials under pressure conditions below atmospheric pressure and temperatures sufficient to melt the plastic material. The reactor includes agitation that exposes the plastic material to the atmosphere within the reactor to promote the volatilization of the PCBs.

What is claimed:

1. A method for removing polychlorinated biphenyls (PCBs) from plastic material comprising the steps of:
receiving a waste stream comprising plastic material contaminated with PCBs;
adding the waste stream to a reactor, wherein the pressure within the reactor is maintained at or below 100 millibars;
establishing a temperature of the reactor above the melting point of the plastic material and the boiling point of the PCBs at the pressure within the reactor to create a molten plastic material;
agitating the molten plastic material; and
extruding the molten plastic material following volatilization of at least a fraction of the PCBs from the plastic material.

2. The method of claim 1 wherein the pressure within the reactor is maintained at or below 10 millibars.

3. The method of claim 1 wherein the pressure within the reactor is maintained at approximately 1 millibar.

4. The method of claim 1 further comprising the step of cleaning the waste stream prior to adding the waste stream to the reactor.

5. The method of claim 1 wherein the waste stream comprises residue from shredding an automobile.

6. The method of claim 1 further comprising the step of pelletizing the extruded plastic material.

7. The method of claim 1 wherein the step of agitating the waste material comprises exposing the entire the volume of plastic material to the atmosphere in the reactor.

8. The method of claim 1 further comprising the step of introducing a solvent into the reactor, wherein the solvent distills PCBs from the molten plastic material.

9. The method of claim 8 wherein the solvent is selected from a group consisting of water vapor, 50/50 acetone/hexane or methylene chloride.

10. The method of claim 1 further comprising the step of screening the molten plastic material while extruding the molten plastic material from the reactor.

11. The method of claim 1 wherein the step of extruding the molten plastic material comprises directly forming the molten plastic into a finished product.

12. A method for removing polychlorinated biphenyls (PCBs) from plastic material comprising the steps of:
receiving a waste stream comprising a volume of plastic material contaminated with PCBs;
cleaning the volume of plastic material;
adding the plastic material to a kneader reactor, wherein the pressure within the kneader reactor is maintained at or below 10 millibars;
establishing a temperature of the kneader reactor above the melting point of the volume of plastic material and the boiling point of the PCBs at the pressure within the kneader reactor to form a molten plastic material;
agitating the molten plastic material to expose the volume of plastic material to the atmosphere in the kneader reactor; and
extruding the molten plastic material following volatilization of at least a fraction of the PCBs from the plastic material.

13. The method of claim 12 wherein the waste stream comprises residue from shredding an automobile.

14. The method of claim 12 further comprising the step of pelletizing the extruded plastic material.

15. The method of claim 12 further comprising the step of introducing a solvent into the kneader reactor, wherein the solvent distills PCBs from the molten plastic material.

16. The method of claim 15 wherein the solvent is selected from a group consisting of water vapor, 50/50 acetone/hexane or methylene chloride.

17. The method of claim 12 wherein the step of extruding the molten plastic material comprises directly forming the molten plastic into a finished product.

18. The method of claim 12 further comprising the step of screening the molten plastic material while extruding the molten plastic material from the kneader reactor.

19. The method of claim 12 further comprising the step of pre-processing the waste stream to concentrate the plastic material in the waste stream.

20. The method of claim 12 wherein the step of agitating the waste material to expose the volume of plastic material to the atmosphere in the kneader reactor comprises forming thin segments of the plastic material.
